(19) United States
(12) Patent Application Publication
(10) Pub. No.: US 2006/0206729 A1
(43) Pub. Date: Sep. 14, 2006

(54) Flexible power reduction for embedded components

(76) Inventors: Christian Hentschel, Cottbus (DE); Abraham Karel Riemens, Eersel (NL)

Correspondence Address: PHILIPS INTELLECTUAL PROPERTY & STANDARDS, P.O. BOX 3001, BRIARCLIFF MANOR, NY, 10510, US

(21) Appl. No.: 10/566,554

(22) PCT Filed: Jul. 26, 2004
(86) PCT No.: PCT/IB04/51290

§ 371 Date: Jan. 27, 2006

(30) Foreign Application Priority Data
Jul. 30, 2003 (EP) 03102338.5

(51) Int. Cl. G06F 1/00

(52) U.S. Cl. 713/300

(57) ABSTRACT

Programmable platforms include components such as a central processing unit (CPU), coprocessors (COP I, COP2), and a shared system bus (SB) that connects the various processors. In media processing applications, the processing of the functions is distributed to the central processing unit and the coprocessors. Such functions may be effected in hardware, in software, or in a mixture thereof. The utilization of each coprocessor may vary both for different applications as well during execution of a single application, depending on the character of the media processing application. As a result, one or more coprocessors may not be effectively utilized during a certain part of the media processing. In case of a synchronous system those coprocessors continue consuming power. According to the invention, a coprocessor can be powered down by a local controller, depending on the workload of that coprocessor. As a result, power control is distributed and automatic, and only depends on required processing capacity of the coprocessor.

### TECHNICAL FIELD

Data processing system, method for processing data.

### BACKGROUND ART

Programmable platforms may include components such as a central processing unit (CPU), one or more coprocessors, and a shared bus that connects the various processors. In media processing applications, the processing of the functions is distributed to the central processing unit and the coprocessors. Such functions may be defined in hardware, in software, or in a mixture thereof. This choice may depend, amongst others, on the function itself, the manufacturing volume of the function, and the circuit in question. The CPU is software controlled and can be adapted to many different desired purposes by the use of suitable software, providing a great flexibility. A coprocessor is dedicated to execute a specific function. In general, for a given function, a software-controlled processor is usually less efficient in silicon area and power consumption than a coprocessor dedicated to that function, but on the other hand a software-controlled processor is more flexible. The CPU may also act as a controller for the platform.

The media processing may include video, graphics or audio processing. The utilization of each coprocessor may vary both for different applications as well during execution of a single application, depending on the character of the media processing application or the mode of operation for certain use cases. As a result, one or more coprocessors may not be effectively utilized during a certain part of the media processing. In case of a synchronous system those coprocessors continue consuming power, since they still receive a clock signal. In order to reduce the power consumption of synchronous programmable platforms, the clock frequency of the platform can be lowered, according to the coprocessor with the highest utilization. Another approach is to lower the supply voltage of the platform. Unused coprocessors can also be powered down statically. However, in all these cases a substantial amount of the coprocessors will still provide more processing capacity than required at a specific moment and therefore also consume more power than required.

### DISCLOSURE OF INVENTION

It is an object of the invention to provide a data processing system having a distributed power control, allowing to dynamically power down an individual component.

This object is achieved with a data processing system, comprising a plurality of processing elements, which are arranged for synchronously processing data under control of at least one clock facility. The data processing system further comprises at least one local controller associated with a processing element of the plurality of processing elements, and a data communication means arranged for exchanging data between processing elements of the plurality of processing elements, wherein the local controller is arranged for powering down its associated processing element depending on the required processing capacity of that processing element. Depending on the workload of a coprocessor, the local controller powers down the coprocessor, allowing a dynamic power control. Since each coprocessor may have a local controller, the power management is distributed over the processing system, i.e. a global control mechanism for power management is not required. Such a global control mechanism introduces a substantial amount of overhead, especially in case of data processing system with a relatively large number of processing elements, and the difference in use-cases may complicate this further. The power control of an individual coprocessor is transparent to the rest of the processing system, meaning that the other coprocessors have no need to know about the current power status of that specific coprocessor. At any time, if required, any processing element or a combination of processing elements will become available automatically. Powering down of a processing element includes both completely switching off power for the processing element as well as putting the processing element in a sleep mode.

US2002/0007463A1 describes a computer system comprising a number of units that operates as servers. Each unit has at least one processor and an activity monitor that identifies the level of activity for the processor. Each unit is operable in three different modes, having mutually different power consumption rates. A controller is coupled to the units of the computer system and receives information on the level of activity from each unit. The controller analyses this information and determines an operating mode for each unit Subsequently, the controller generates commands to each unit for directing that unit to operate in the determined operating mode. However, this document does not disclose a distributed power management system without the need of a global control mechanism.

US2003/0025689A1 describes a power management method for an electronic device, such as a computer system. The method comprises several power conservation techniques, including static power controls, dynamic power controls and a flexible clock generator that may include one or more different programmable clock policies with programmable clock rates. The static power control is used for powering down any unused functional modules at different times. The dynamic power control utilizes the clocking mechanism to reduce power consumption of the complete system. Using the flexible clock generator the appropriate clock speed is set to provide just enough clock speed for the particular task at hand. It does not disclose, however, how to dynamically power down one or more hardware units separately.

An embodiment of the invention is characterized in that the data processing system further comprises at least one buffer associated with the processing element of the plurality of processing elements, wherein the buffer is arranged for exchanging data between its associated processing element and the data communication means, and wherein the local controller is arranged to determine the required processing capacity of its associated processing element from the filling degree of the associated buffer. Using the filling degree of the associated buffer is a relatively simple way of determining the workload of the associated processing element. In case the buffer is empty, the local controller powers-down the processing element. As soon as the buffer is at least partially filled again, the local controller powers up the processing element.

An embodiment of the invention is characterized in that the data processing system further comprises a control processor, wherein the local controller is arranged to receive information on the required processing capacity of the associated processing element from the control processor, and wherein the local controller is further arranged to have information on the processing capacity of the associated processing element. Using the information, the local controller determines the time interval that the corresponding processing element is idle, and powers down the processing element, depending on the length of this time interval. Once the processing element receives new data to process, the local controller powers up the corresponding processing element.

An embodiment of the invention is characterized in that the processing element of the plurality of processing elements is further arranged to generate an interrupt for notifying its associated local controller on the required processing capacity. In case the processing element has finished processing data, it notifies its corresponding local controller. Subsequently, the local controller powers down the processing element. At the moment new data for processing arrive, the processing element is powered up again.

An embodiment of the invention is characterized in that a sequence of clock cycles effects a processing operation of an amount of data, wherein the data processing system further comprises programmable means for implementing programmable stall clock cycles for the processing element of the plurality of processing elements, wherein the programmable stall clock cycles are interspersed between clock cycles of the sequence of clock cycles. In case blocks of data are offered on regular times, it may be the case that the processing of a block of data has already finished before the next block of data has arrived. Programming of stall cycles between the clock cycles for processing of data can be used in order to reduce the peak load of bandwidth consumption of a coprocessor. On the other hand, the remaining time can be used to power down the coprocessor for reasons of power savings. An advantage of this embodiment is that it allows exploiting the trade off between spreading the bandwidth consumption and power savings, and making an optimization depending on the requirements of the system.

An embodiment of the invention is characterized in that at least one processing element is associated with a bandwidth control unit for controlling a rate of its data transfer along the data communication means, the bandwidth control unit restricting the data transfer if it exceeds an allowed maximum data rate. In case blocks of data are offered for processing on regular times, it may be the case that the processing of a block of data has already finished before the next block of data has arrived. The bandwidth control unit can adapt the consumption of bandwidth by a processing element to a level that is suitable for the function actually performed. The bandwidth consumption can be averaged over the time interval between the arrivals of two data blocks. Alternatively, the remaining time can be used to power down the coprocessor. As in case of a previous embodiment, an optimization between spreading the bandwidth consumption and power savings can be made, depending on the system requirements.

Further embodiments of the invention are described in the dependent claims.

According to the invention, a method for processing data according to claim 9 is provided as well.

### BRIEF DESCRIPTION OF FIGURES

FIG. 1 shows an embodiment of a data processing system according to the present invention.

FIG. 2 shows another embodiment of a data processing system according to the present invention.

FIG. 3 shows an embodiment of a bandwidth control unit.

### DESCRIPTION OF EMBODIMENTS

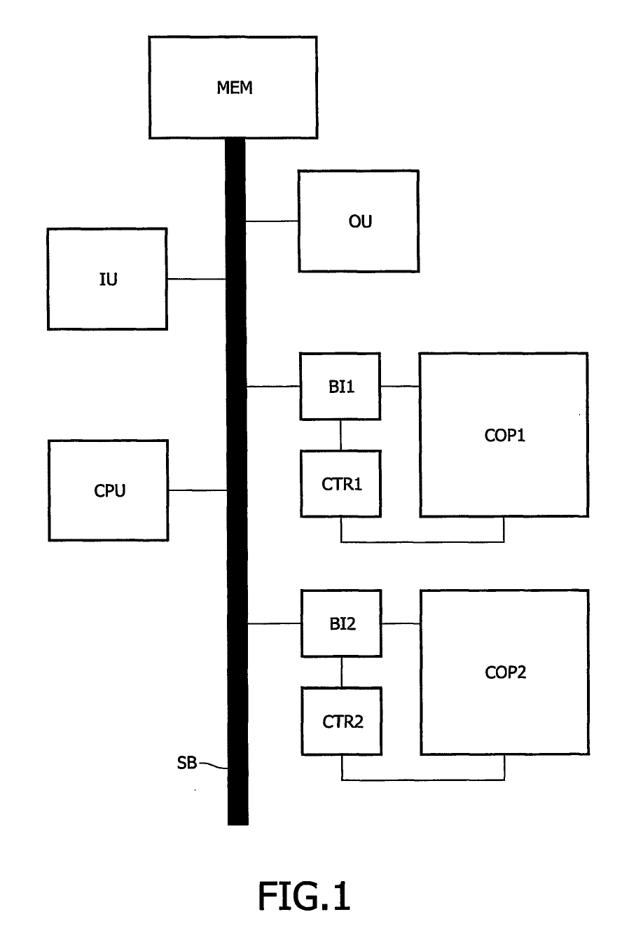

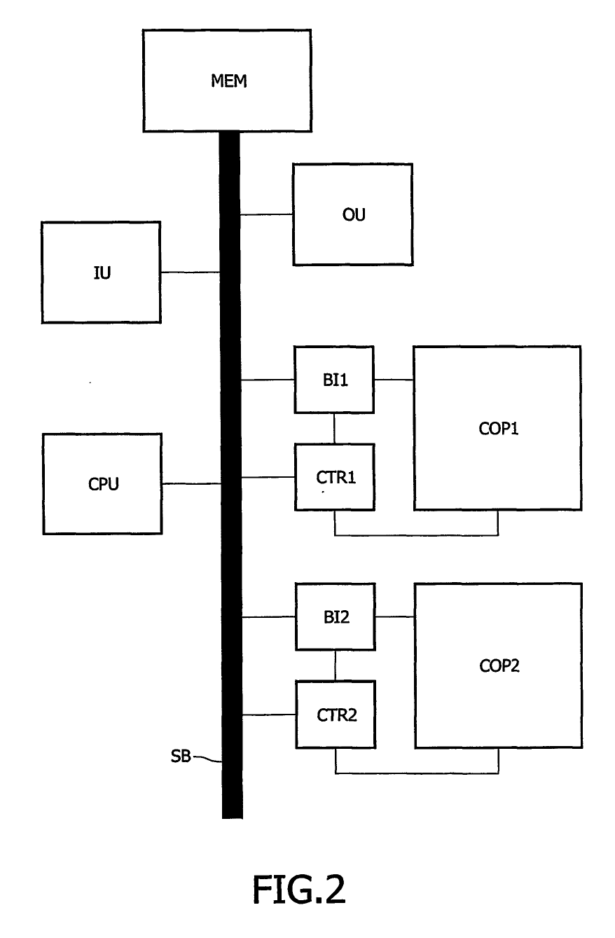

FIG. 1 and FIG. 2 illustrate embodiments of a data processing system according to the present invention. Referring to both FIGS. 1 and 2, the data processing system comprises a system bus SB, a shared memory MEM, an input unit IU, an output unit OU, a central processing unit CPU, coprocessors COP1 and COP2, bus interfaces BI1 and BI2, and local controllers CTR1 and CTR2. The data processing system also comprises a system clock, not shown in FIGS. 1 and 2, for sending clock signals to all components of the system. In alternative embodiments, the data processing system may have a plurality of clocks for operation of different components of the system at a different clock speed. The system bus SB and the memory MEM are shared by the central processing unit CPU, input unit IU, output unit OU and coprocessors COP1 and COP2. The data processing system executes media processing applications, for example in the field of video, graphics or audio processing. The central processing unit CPU controls the overall system. Next to controlling the memory MEM, the central processing unit CPU may immediately access various control registers in the coprocessors COP1 and COP2. The central processing unit CPU may also execute a software program containing parts of the functionality of the media processing application. The coprocessors COP1 and COP1 are dedicated for executing specific media processing functions in hardware, and these functions of the media processing application are mapped onto the coprocessors COP1 and COP2. For example, in case of an MPEG application, functions representing a Discrete Cosine Transform (DCT) function or a motion estimation function, can be mapped onto coprocessors COP1 and COP2 respectively, which are dedicated to execute these specific functions. Input data, such as speech or image input, is received via the input unit IU and are subsequently processed by central processing unit CPU and coprocessors COP1 and COP2. The output data are written to the output unit OU, which outputs the data to another data processing system, or to a display device, to name a few. In some embodiments, the input unit IU receives input data at regular time intervals. In other embodiments, the input unit IU receives bursts of input data, depending on the media application or the source of input data, to name a few. In some embodiments, the output unit OU may output data at regular time intervals. In different embodiments the output unit OU outputs data in bursts. Intermediate results obtained during the data processing can be stored by the coprocessors COP1 and COP2 or the central processing unit CPU in the memory MEM, via the system bus SB, and subsequently retrieved from the memory MEM for further processing. Since various ones of the coprocessors COP1 and COP2, input unit IU, output unit IO, and central processing unit CPU can initialize transfer of data via the system bus SB independent of the others, an arbitration mechanism is necessary to sequentialize the bus transfers, and in the case shown, for controlling memory accesses. For this purpose a bus arbiter, not shown in FIGS. 1 and 2, can be used. The coprocessors COP1 and COP2 communicate with the system bus SB via bus interface BI1 and BI2, respectively. These bus interfaces BI1 and BI2 comprise an input buffer for buffering data that has to be transferred from the system bus SB to the coprocessor, and an output buffer for buffering data that has to be transferred from the coprocessor to the system bus SB. In alternative embodiments, two separate bus interfaces can be used for a coprocessor, comprising an input buffer and an output buffer, respectively. In yet another embodiment, a coprocessor may have multiple bus interfaces for receiving input data and/or multiple bus interfaces for outputting data, for example for transferring data related to different images via different bus interfaces. The input and output buffers allow the system bus SB to work independently of the coprocessors COP1 and COP2. The local controllers CTR1 and CTR2 can power down the coprocessors COP1 and COP2, respectively, depending on the workload of those coprocessors, as will be explained in the next paragraphs. The coprocessors COP1 and COP2 can be implemented by, for example, dedicated hardware, a programmable processor loaded with software to execute a dedicated function, for example a Very Large Instruction Word processor, or reconfigurable hardware, for example a Field Programmable Gate Array.

In different embodiments, the data processing system may have more than two coprocessors, or a different number of CPUs, or a different number of memory units, depending, for example, on the type of media processing application for which the data processing system is designed. Alternatively, the input unit IU and output unit OU can be integrated in a coprocessor.

Referring now to FIG. 1, local controller CTRL is coupled to bus interface BI1 and local controller CTR2 is coupled to bus interface BI2. During data processing, input data are transferred to the input buffers of the bus interfaces BI1 and BI2. The data processing may include streaming processing, i.e. processing of video fields or frames, slices of data, to name a few, within regular processing periods. The coprocessors COP1 and COP2 read these data from the corresponding input buffer of bus interfaces BI1 and BI2, process the data and write the result data to the corresponding output buffers of the bus interfaces BI1 and BI2. Via the system bus SB the result data are written to memory MEM, or to the output unit OU. The system bus SB is a shared resource, and during data processing the situation may occur that coprocessor COP1 initializes a request to retrieve data from memory MEM via the system bus SB, while at that moment a series of bus requests by other components of the data processing system is still pending. The bus request of coprocessor COP1 is added to the queue of bus requests, while coprocessor COP1 continues processing data that are stored in the input buffer of BI1. At the moment that input buffer is empty, the coprocessor COP1 is stalled by the bus interface BI1. The local controller CTR1 detects that the corresponding input buffer is empty, and powers down the coprocessor COP1. As soon as the bus request initialized by coprocessor COP1 is handled, data are written from memory MEM to the input buffer of bus interface BI1. The local controller CTR1 detects that the input buffer of bus interface BI1 contains data, and powers up the coprocessor COP1, which continues processing data from the corresponding input buffer. As a result, a dynamic, distributed power control is obtained, depending only on the amount of data that a coprocessor has to process. Furthermore, the local controller only requires relatively simple hardware. In an alternative embodiment, the processing element is powered up only after a certain amount of data is present in the corresponding input buffer. In some embodiments, the input unit IU and/or the output unit OU may also have a local controller, which powers down the corresponding unit in case no data are received or output, respectively, for example in case the transfer of data goes via bursts.

Referring to FIG. 2, local controller CTRI1 is coupled to bus interface BI1, local controller CTR2 is coupled to bus interface BI2, and the local controllers CTR1 and CTR2 are both coupled to the system bus SB. During streaming processing, the central processing unit CPU activates the coprocessors COP1 and COP2 to start processing data by writing information in the control registers of the coprocessors. This information may include: memory addresses of the memory MEM, height and width of a video frame to be processed and the number of frames per second that have to be processed by that coprocessor. The height and width of a video frame relate to the amount of data that has to be processed for one video frame. At the moment the coprocessor COP1 or COP2 has finished processing data for a given video frame, the coprocessor generates an interrupt to notify the central processing unit CPU. In an embodiment of the present invention, the coprocessors COP1 and COP2 also sent an interrupt to the corresponding local controller CTR1 and CTR2, which subsequently power down the coprocessor COP1 and COP2, respectively. In another embodiment, the local controllers CTR1 and CTR2 have registers to store information on the number of frames per second that the corresponding coprocessor has to process. This information can be stored in the registers of coprocessors COP1 and COP2 by the central processing unit CPU. Using this information, the local controllers CTR1 and CTR2 calculate the time interval between the receipts of two video frames. At the moment the coprocessors COP1 and COP2 start processing a series of video frames, the corresponding local controller starts an internal timer. When the coprocessors COP1 and COP2 finish processing a video frame, an interrupt is sent to local controllers CTR1 and CTR2 respectively. The local controllers CTR1 and CTR2 determine the time interval between the receipt of the interrupt and the start of the processing of a next video frame. Depending on the length of that time interval, the local controllers CTR1 and CTR2 power down the corresponding coprocessor COP1 and COP2. Powering down and up within regular processing periods has its limits, because the operation to power down and to power up a coprocessor consumes power as well. The local controllers CTR1 and CTR2 can have a programmable register, for example, for storing a minimum value for the time interval between receipt of the interrupt and start of the processing of a next frame. Only in case the actual time interval is equal to or larger than this minimum value, the local controllers CTR1 and CTR2 power down the corresponding coprocessor. At the moment the processing of a next video frame should start, the local controllers CTR1 and CTR2 power up the coprocessors COP1 and COP2, respectively. In an alternative embodiment, the coprocessors COP1 and COP2 are powered up by the central processing unit CPU, when it requests for processing a next block of data.

In another embodiment of the invention, the central processing unit CPU can be further programmed to implement stall cycles for coprocessors COP1 and COP2, interspersed between clock cycles of the sequence of clock cycles used for processing of data by the coprocessors. During a stall cycle the coprocessors COP1 and COP1 still receive a clock signal, but do not respond due to stall cycles generated by their corresponding local controller. The usage of stall cycles for lowering the actual data transfer rate is further described in U.S. Copending application Ser. No. 09/920,042 (Attorney Docket PHNL010506), also assigned to the present assignee, herein incorporated by reference. In distributed data processing, data may be presented to or may be required from the system bus SB on short notice and/or in high-intensity bursts. When such transfers would occur within short time frames, overall system bus capacity would readily and frequently be exceeded, which would then lead to a stall situation for the component requesting the transfer. The stall cycles can be used to lower the actual transfer rate of data via the system bus SB, since when a coprocessor executes one or more stall cycles no bus requests are made by that coprocessor. An advantage of this embodiment is that it allows the trade-off between reducing the power consumption of a coprocessor and spreading the consumption of bandwidth of the system bus SB in time. In case the actual processing time of a coprocessor for a given set of data, for example a video frame, is less that the time interval between two video frames, this time difference can be used for spreading the bandwidth consumption by adding programmable stall cycles in between the normal processing cycles, or to power down the coprocessor during a period of time for each time interval between two video frames, as describes in a previous embodiment. Depending on the media processing application, the configuration of the data processing system and the system requirements, an optimization between spreading the bandwidth consumption and reducing the power consumption can be made.

Referring again to FIG. 2, in yet another embodiment the local controllers CTR1 and CTR2 further comprise a so-called bandwidth control unit. The usage of a bandwidth control unit for lowering the actual data transfer rate is further described in United States Copending Application (Attorney Docket PHNL030795), also assigned to the present assignee, herein incorporated by reference. Using these bandwidth control units, the consumption of bandwidth by coprocessors COP1 and COP2 can be controlled by the corresponding local controller CTR1 and CTR2, thereby effectively slowing down the average data processing speed of the coprocessors COP1 and COP2, respectively. However, if necessary, additional transfer capability can be provided, so that in most cases no longer a stall situation would prevail. Bus arbitration, for example by means of a bus arbiter, is still necessary, since the coprocessors COP1 and COP2 can still initiate bus transfers simultaneously. The local controllers CTR1 and CTR2 further have registers to store information on the height and width of a video frame, the number of frames per second that the corresponding coprocessor has to process and the compute capacity of the corresponding coprocessor. This information can be stored in the registers by the central processing unit CPU. Using this information, the local controllers CTR1 and CTR2 calculate the minimum time that is required by the corresponding coprocessor to process the data for one video frame, the time interval between the receipt of two video frames, and the allowed maximum data rate for bandwidth consumption. The allowed maximum data rate is based on the height and width of a video frame and a chosen time interval, which is at most the time interval between two video frames. The bandwidth control units restrict the average bandwidth consumption of the corresponding coprocessor COP1 and COP2 to their allowed maximum data rate. In case the coprocessors COP1 and COP2 have less bandwidth available than their own quoted bandwidth in a certain period during processing of a video frame, they can in principle catch up for the discrepancy in a subsequent time period, before the receipt of the next video frame. In a particular advantageous embodiment such catch-up time is provided in a brief so-called slack time that is situated at the end of the time interval between two video frames and for which the maximum system bus bandwidth has been specified. At the moment the coprocessors COP1 and COP2 start processing a series of video frames, the corresponding local controller starts an internal timer. When the coprocessors COP1 and COP2 finish processing a video frame, an interrupt is sent to local controllers CTR1 and CTR2 respectively. The local controllers CTR1 and CTR2 determine the time period between the receipt of the interrupt and the start of the processing of a next video frame. Depending on the length of this time interval, the local controllers CTR1 and CTR2 may power down the corresponding coprocessor COP1 or COP2. The local controllers CTR1 and CTR2 can have a programmable register, for example, for storing a minimum value for the time interval between receipt of the interrupt and start of the processing of a next frame. Only in case the actual time interval is equal to or larger than this minimum value, the local controllers CTR1 and CTR2 power down the corresponding coprocessor. At the moment the processing of a next video frame should start, the local controllers CTR1 and CTR2 power up the coprocessors COP1 and COP2, respectively. An advantage of this embodiment is that it allows the trade-off between reducing the power consumption of a coprocessor and spreading the consumption of bandwidth of the system bus SB in time. The time interval for calculating the allowed maximum data rate of a coprocessor can be chosen equal to the time interval between two video frames, and in this case the bandwidth consumption of that coprocessor is maximally spread. On the other hand, the time interval for calculating the allowed maximum data rate can be chosen equal to the minimum time required for processing the video frame, allowing the coprocessor to be powered down during the remainder of the time interval between two video frames and maximizing the reduction in power consumption. Depending on the media processing application, the configuration of the data processing system and the system requirements, an optimization between spreading the bandwidth consumption and reducing the power consumption can be made.

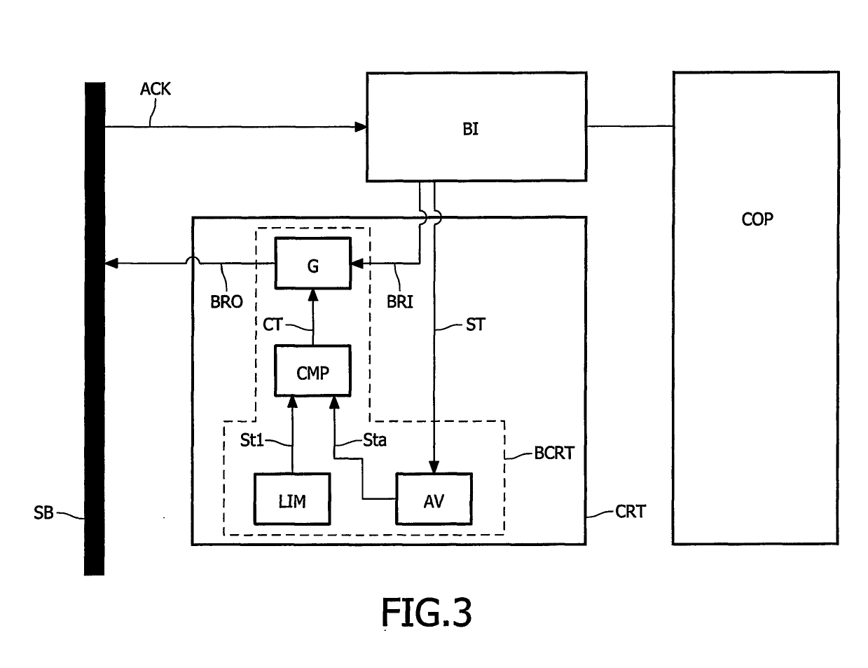

FIG. 3 shows an embodiment of a control unit CTR comprising a bandwidth control unit BCTR, as well as a coprocessor COP coupled via a bus interface BI to a system bus SB. The bandwidth control unit comprises an average calculation unit AV to calculate an average amount of data Sta transferred via the bus interface BI to the system bus. To that end the average calculation unit receives a signal St indicative for the amount of data transfer taking place via the bus interface BI. The bandwidth control unit BCTR further comprises a register LIM for storing an indication for the allowed maximum data rate Stl. A comparator CMP compares these signals and controls a gate G with control signal CT. Normally the gate G transmits a bus request BRI from the bus interface BI as the signal BRO to a bus arbiter, and the bus arbiter will respond with an acknowledge signal ACK if the bus is available. However, if the average amount of data Sta transferred via the bus interface BI to the system bus exceeds the allowed maximum data rate Stl, the control signal CT causes the gate G to block the bus request signal BRI. In that case no request BRO is received by the arbiter, and further data transmission is prevented until the average value Sta has decreased to a value below the allowed value Stl. On the other hand, if it occurs that the system bus SB has not been available for some time, because another device, for example a CPU having a high priority has occupied the bus, the average amount of data Sta transferred is substantially lower than the allowed value Stl. In that case the coprocessor COP has the occasion to temporarily increase data transfer until the average value Sta again reaches the allowed value Stl.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A data processing system, comprising:
a plurality of processing elements (COP1, COP2), which are arranged for synchronously processing data under control of at least one clock facility;
at least one local controller (CTR1, CTR2) associated with a processing element of the plurality of processing elements;
a data communication means (SB) arranged for exchanging data between processing elements of the plurality of processing elements,
wherein the local controller is arranged for powering down its associated processing element depending on the required processing capacity of that processing element.

2. A data processing system according to claim 1, wherein the local controller is further arranged for powering up its associated processing element depending on the required processing capacity of that processing element.

3. A data processing system according to claim 1, further comprising:
at least one buffer (BI1, BI2) associated with the processing element of the plurality of processing elements, wherein the buffer is arranged for exchanging data between its associated processing element and the data communication means,
and wherein the local controller is arranged to determine the required processing capacity of its associated processing element from the filling degree of the associated buffer.

4. A data processing system according to claim 1, further comprising a control processor,
wherein the local controller is arranged to receive information on the required processing capacity of the associated processing element from the control processor,
and wherein the local controller is further arranged to have information on the processing capacity of the associated processing element

5. A data processing system according to claim 1, wherein the processing element of the plurality of processing elements is further arranged to generate an interrupt for notifying its associated local controller on the required processing capacity.

6. A data processing system according to claim 1, wherein a sequence of clock cycles effects a processing operation of an amount of data,
wherein the data processing system further comprises programmable means for implementing programmable stall clock cycles for the processing element of the plurality of processing elements, wherein the programmable stall clock cycles are interspersed between clock cycles of the sequence of clock cycles.

7. A data processing system according to claim 1, wherein at least one processing element is associated with a bandwidth control unit (BCTR) for controlling a rate of its data transfer along the data communication means, the bandwidth control unit restricting the data transfer if it exceeds an allowed maximum data rate.

8. A data processing system according to claim 1, further comprising a memory facility (MEM),
wherein the data communication means is further arranged for exchanging data between the memory facility and the processing elements of the plurality of processing elements.

9. A method for processing data, using a data processing system, comprising:
a plurality of processing elements (COP1, COP2), which are arranged for synchronously processing data under control of at least one clock facility;
at least one local controller (CTR1, CTR2) associated with a processing element of the plurality of processing elements;
a data communication means (SB) arranged for exchanging data between processing elements of the plurality of processing elements,
wherein the method comprises the following steps:
supplying data to the processing element;
powering down of the processing element by the local controller if no data are available for processing by the processing element;

10. A method for processing data according to claim 9, wherein the method further comprises the following step:
powering up of the processing element by the local controller if data are available for processing by the processing element.
